(19) United States
(12) Patent Application Publication
(10) Pub. No.: US 2006/0042885 A1
(43) Pub. Date: Mar. 2, 2006

(54) Elevator

(75) Inventors: Kan Kawasaki, Tokyo-To (JP); Takashi Ishii, Chiba-Ken (JP); Hiroshi Sano, Tokyo-To (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Elevator Kabushiki Kaisha, Tokyo (JP)

(21) Appl. No.: 10/524,670

(22) PCT Filed: Aug. 5, 2003
(86) PCT No.: PCT/JP03/09940

§ 371 Date: Feb. 11, 2005

(30) Foreign Application Priority Data
Aug. 14, 2002 (JP) 2002-236638

(51) Int. Cl. B66B 7/02

(52) U.S. Cl. 187/406

(57) ABSTRACT

An elevator comprises a cage (2) suspended in an elevator shaft (5) and provided with cage-side sheaves (2a, 2b); a counterweight (3) suspended in the elevator shaft (5) and provided with a counterweight-side sheave (3a); a diverting sheave (11) disposed at a position above the counterweight (3) in an upper part of the elevator shaft (5); first and second upper sheaves (9, 12) disposed in an upper part of the elevator shaft (5); and a main rope (4) wound around the first and the second upper sheaves (9, 12), and having a first part wound around the cage-side sheaves (2a, 2b) and having a first end fastened to a fixed structure in an upper part of the elevator shaft (5), and a second part passed successively via the counterweight-side sheave (3a) of the counterweight (3) and the diverting sheave (11) and having a second end fastened to the counterweight (3).

### BACKGROUND OF THE INVENTION

1. Field of the Invention

The present invention relates to an elevator having no machineroom and including a cage and a counterweight suspended in an elevator shaft so as to move vertically in a jig-back manner.

2. Description of the Related Art

Referring to FIGS. 13 and 14 showing a conventional elevator 100 having no machineroom, the elevator 100 includes a cage 102 suspended in an elevator shaft 101 and provided with cage-side sheaves 102a, a counterweight 103 suspended in the elevator shaft 101 and provided with a counterweight-side sheave 103a, an upper sheave 104 disposed in an upper part of the elevator shaft 101, and a main rope 105 having opposite ends fastened to the top wall of the elevator shaft 101. The main rope 105 extends via the cage-side sheaves 102a of the cage 102, the upper sheave 104 and the counterweight-side sheave 103a of the counterweight 103. Thus, the cage 102 and the counterweight 103 are suspended in the elevator shaft 101 by the main rope 105 in a so-called jig-back manner.

A part of the main rope 105 extending between the upper sheave 104 and the cage-side sheaves 102a of the cage 102 is successively wound around a drive sheave 106a included in a hoist 106 disposed in a lower part of the elevator shaft 101, and a diverting sheave 107 disposed in an upper part of the elevator shaft 101. The cage 102 and the counterweight 103 move vertically relative to each other by the main rope 105 with the driving force of the hoist 106.

As shown in FIG. 14, the cage 102, the counterweight 103, cage-side guide rails 108a and 108b for guiding the cage 102, the counterweight 103, the hoist 106, the upper sheave 104 and the diverting sheave 107 are disposed so as not to overlap mutually when viewed in a vertical direction to form the elevator 100 having no machineroom with a reduced overall height.

In the aforesaid conventional elevator 100, parts of the main rope 105 respectively extending on the opposite sides of the upper sheave 104 are wound around the cage-side sheaves 102a of the cage 102 and the counterweight-side sheave 103a of the counterweight 103, respectively, and the opposite ends of the main rope 105 are fastened to the top of the elevator shaft 101. Therefore, the respective strokes of the cage 102 and the counterweight 103 in the elevator shaft 101 are substantially equal to each other. That is, the vertical moving stroke of the counterweight 103, as well as the vertical moving stroke of the cage 102, is approximately equal to the overall height of the elevator shaft 101. Thus, the weight of the counterweight 103 needs to be changed so that the counterweight 103 may not overlap the rest of the component of the elevator 100 when viewed in a vertical direction.

Since the cage 102, the counterweight 103, the cage-side guide rails 108a and 108b, the hoist 106, the upper sheave 104 and the diverting sheave 107 are disposed so that they may not overlap each other when viewed in a vertical direction, it is impossible, in some cases, to secure a sufficient space for the cage-side guide rails 108a and 108b, the hoist 106, the upper sheave 104 and the diverting sheave 107 when the counterweight 103 becomes large.

If it is impossible to secure a sufficient space for the cage-side guide rails 108a and 108b, the hoist 106, the upper sheave 104 and the diverting sheave 107, sometimes the attitude of the cage 102 becomes unstable while the cage 102 is moving vertically, depending on the manner for suspending the cage 102 with the main rope 105 in the elevator shaft 101 and the arrangement of the cage-side guide rails 108a and 108b. Consequently, in a conventional elevator 100 mentioned above, the counterweight 103 cannot be enlarged.

### SUMMARY OF THE INVENTION

The present invention has been made in view of the aforesaid problems in the conventional elevator and it is therefore an object of the present invention to provide an elevator having no machineroom, including a counterweight having comparatively small vertical projected area.

According to a first aspect of the present invention, an elevator comprises: a cage vertically moving in a cage moving space arranged in an elevator shaft, and having at least one cage-side sheave; a counterweight vertically moving in a counterweight moving space arranged beside the cage moving space in the elevator shaft, and having at least one counterweight-side sheave; a diverting sheave disposed above the counterweight moving space; a pair of upper sheaves disposed in a top part of the counterweight moving space; a hoist disposed in a space in the elevator shaft other than both the cage moving space and the counterweight moving space, and having a drive sheave positioned below the pair of upper sheaves; and a main rope successively wound around the cage-side sheave, one of the pair of upper sheaves, the drive sheave, the other upper sheave, the counterweight-side sheave and the diverting sheave, said main rope having a first end fastened to an upper part of the elevator shaft and a second end fastened to the counterweight.

In the elevator in the first aspect of the present invention, the cage and the counterweight are suspended with the main rope in a manner mentioned above. Therefore, the vertical moving stroke of the counterweight in the elevator shaft become less than that of the cage. Hence, an empty space, in which the counterweight does not move vertically, can be obtained above or below the counterweight moving space in the elevator shaft. This empty space can be used for a vertical moving space of the counterweight having a greater height to achieve larger weight, without modifying the arrangement of the guide rails and sheaves.

Further, since the empty space can be obtained above the counterweight moving space, a sufficient space for disposing the diverting sheave can be obtained even if the vertical size of the counterweight can be increased.

According to a second aspect of the present invention, an elevator comprises: a cage vertically moving in a cage moving space arranged in an elevator shaft, and having at least one cage-side sheave; a counterweight vertically moving in a counterweight moving space arranged beside the cage moving space in the elevator shaft, and having a plurality of counterweight-side sheaves; a plurality of diverting sheaves disposed above the counterweight moving space; a pair of upper sheaves disposed in a top part of the counterweight moving space; a hoist disposed in a space in the elevator shaft other than both the cage moving space and the counterweight moving space, and having a drive sheave positioned below the pair of upper sheaves; and a main rope successively wound around the cage-side sheave, one of the pair of upper sheaves, the drive sheave, the other upper sheave, one of the counterweight-side sheaves, one of the diverting sheaves, the other counterweight-side sheave, and the other diverting sheave, said main rope having a first end fastened to an upper part of the elevator shaft and a second end fastened to the counterweight.

In the elevator in the second aspect of the present invention, the cage and the counterweight are suspended with the main rope in a manner mentioned above. Especially, the counterweight is suspended with the main rope wound around between the counterweight-side sheaves and the diverting sheaves in alternation. Therefore, the vertical moving stroke of the counterweight in the elevator shaft is many times less than that of the cage. Hence, an greater empty space, in which the counterweight does not move vertically, can be obtained above or below the counterweight moving space in the elevator shaft. This greater empty space can be used for a counterweight having a greater height to achieve larger weight, without modifying the arrangement of the guide rails and sheaves.

### BRIEF DESCRIPTION OF THE DRAWINGS

The above and other objects, features and advantages of the present invention will become more apparent from the following description taken in connection with the accompanying drawings, in which:

FIG. 1 is a schematic perspective view of an elevator in a first embodiment according to the present invention;

FIG. 2 is a plan view of the elevator shown in FIG. 1;

FIG. 3 is a side elevation of the elevator shown in FIG. 1;

FIG. 4 is a plan view of an elevator in a second embodiment according to the present invention;

FIG. 5 is a side elevation of the elevator shown in FIG. 4, taken in the direction of the arrow a in FIG. 4;

FIG. 6 is a side elevation of the elevator shown in FIG. 4, taken in the direction of the arrow b in FIG. 4;

FIG. 7 is a plan view of an elevator in a third embodiment according to the present invention;

FIG. 8 is a side elevation of the elevator shown in FIG. 7, taken in the direction of the arrow c in FIG. 7;

FIG. 9 is a side elevation of the elevator shown in FIG. 7, taken in the direction of the arrow d in FIG. 7;

FIG. 10 is a plan view of an elevator in a fourth embodiment according to the present invention;

FIG. 11 is a side elevation of the elevator shown in FIG. 10;

FIG. 12 is a side elevation of an elevator in a modification of the elevator embodiment according to the present invention;

FIG. 13 is a side elevation of a conventional elevator; and

FIG. 14 is a plan view of the conventional elevator shown in FIG. 13.

### DESCRIPTION OF THE PREFERRED EMBODIMENTS

An elevator according to the present invention is described in detail herebelow with reference to the drawings.

### First Embodiment

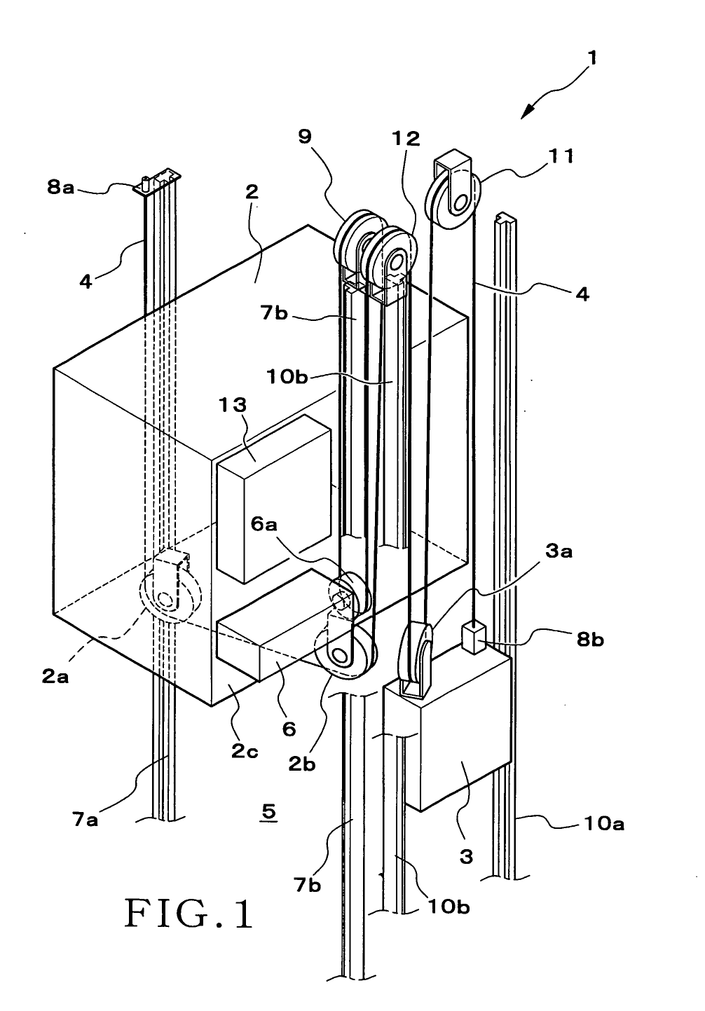

Referring now to FIG. 1, an elevator 1 in a first embodiment according to the present invention has a cage 2, a counterweight 3, and a main rope 4 for suspending the cage 2 and the counterweight 3. The main rope 4 transmits the driving force generated by a hoist 6 disposed in an elevator shaft 5 to the cage 2 and the counterweight 3. The hoist 6 drives the cage 2 and the counter weight 3 for vertical movement in opposite directions in a cage moving space and a counterweight moving space extending beside the cage moving space in the elevator shaft 5, respectively.

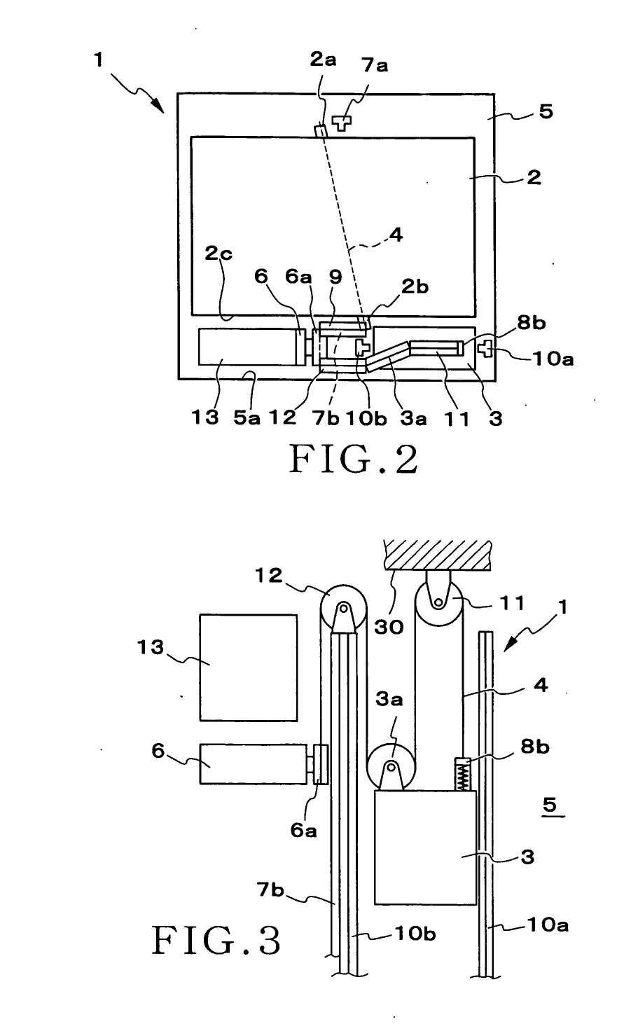

As shown in FIG. 1, the cage 2 is suspended in a space between a pair of cage-side guide rails 7a and 7b. Guide shoes, not shown, attached respectively to the opposite sides of the cage 2 are in sliding engagement with the cage-side guide rails 7a and 7b, respectively. As shown in FIGS. 1 and 2, the cage 2 is provided with a first cage-side sheave 2a and a second cage-side sheave 2b. The cage-side sheaves 2a and 2b are disposed at opposite side positions, respectively, on a bottom structure of the cage 2 such that a part of the main rope 4 extending between the cage-side sheaves 2a and 2b passes the center of the bottom wall of the cage 2 when viewed in a vertical direction.

A rope hitch 8a is attached to the upper end of the cage-side guide rail 7a, and a first end of the main rope 4, i.e., the free end of a first part of the rope 4, is fastened to the rope hitch Ba. A first upper sheave 9 is supported on the upper end of the cage-side guide rail 7b. As shown in FIG. 2, the main rope 4 is extended between the first upper sheave 9 and the second cage-side sheave 2b of the cage 2.

As shown in FIG. 2, the counterweight 3 is suspended in a counterweight moving space, i.e., a space between a sidewall 2c of the cage 2 and a wall 5a of the elevator shaft 5. The counterweight 3, similar to the cage 2, is placed between a pair of counterweight-side guide rails 10a and 10b which are vertically disposed to oppose to each other with the counterweight moving space in the elevator shaft 5 therebetween. Guide shoes, not shown, attached respectively to the opposite sides of the counterweight 3 are in sliding engagement with the counterweight-side guide rails 10a and 10b, respectively.

As shown in FIGS. 1 to 3, a counterweight-side sheave 3a is supported on the top surface of the counterweight 3 on one lateral side part along a sidewall 2c of the cage 2, and a rope hitch Bb is attached to the other lateral side part of the top surface of the counterweight 3. A second end of the main rope 4, i.e., the free end of a second part of the main rope 4, is fastened to this rope hitch 8b.

As shown in FIG. 3, a diverting sheave 11 is disposed above the counterweight moving space and rotatably supported at a top wall 30 of the elevator shaft 5. The diverting sheave 11 is disposed with its axis of rotation extending perpendicularly to the sidewall 2c of the cage 2 when viewed in a vertical direction as shown in FIG. 2. A part of the main rope extends substantially vertically down from one side of the diverting sheave 11 to the center of the rope hitch 8b, and a part of the main rope extends substantially vertically down from the other side of the diverting sheave 11 to one side of the counterweight-side sheave 3a.

As shown in FIGS. 1 to 3, a second upper sheave 12 is supported on the upper end of the cage-side guide rail 10b for guiding the vertical movement of the counterweight 3 with its axis extending in parallel to that of the first upper sheave 9. The first upper sheave 9 and the second upper sheave 12 are at substantially the same level in an upper part of the elevator shaft 5. A part of the main rope 4 extends substantially vertically down from one side of the second upper sheave 12 to the other side of the counterweight-side sheave 3a.

Thus, the hoist 6 drives the cage 2 and the counterweight 3 for vertical movement through the main rope 4. The hoist 6 is fixedly disposed in the space between the other side of the sidewall 2c of the cage 2 and a wall 5a of the elevator shaft 5. When viewed in a vertical direction, the hoist 6 lies below the upper sheaves 9 and 12, and does not overlap the cage 2 and the counterweight 3. The hoist 6 is provided with a drive sheave 6a driven in rotation by means of a driving force of the hoist 6. The axis of rotation of the drive sheave 6a is substantially perpendicular to those of the upper sheaves 9 and 12 when viewed in a vertical direction. The hoist 6 is disposed such that parts of the main rope 4 extend substantially vertically up from the opposite sides of the drive pulley 6a to the other sides of the upper sheaves 9 and 12, respectively. This hoist 6 is controlled by a controller 13.

As shown in FIGS. 1 to 3, the controller 13 is mounted on a control panel fixedly installed at a position near the hoist 6 in the space between the other side of the sidewall 2c of the cage 2 and the wall 5a of the elevator shaft 5. The controller 13 is electrically connected by wires, not shown, to the hoist 6 to send control signals to the hoist 6.

Referring now to FIGS. 1 and 2, the main rope 4 has the first end fastened to the rope hitch 8a attached to the upper end of the cage-side guide rail 7a, and the second end fastened to the rope hitch 8b attached to the counterweight 3. The main rope 4 extends substantially vertically down from the rope hitch 8a, passes the first cage-side sheave 2a and the second cage-side sheave 2b beneath the cage 2, extends substantially vertically up from the second cage-side sheave 2b, passes round the first upper sheave 9, extends substantially vertically down from the first upper sheave 9 to the drive sheave 6a of the hoist 6, passes under the drive sheave 6a, extends substantially vertically up from the drive sheave 6a to the second upper sheave 12, passes round the upper side of the second upper sheave 12, passes round the lower side of the counterweight-side sheave 3a, extends substantially vertically up to the diverting sheave 11, passes round the upper side of the diverting sheave 11 and extends substantially vertically down to the rope hitch 8b attached to the counterweight 3.

Thus, the first part of the main rope 4 is extended from the drive sheave 6a of the hoist 6 via the first upper sheave 9, the cage-side sheaves 2b and 2a and the first end of the first part of the main rope 4 is fastened to the rope hitch 8a disposed in an upper part of the elevator shaft 5. The second part of the main rope 4 is extended from the drive sheave 6a via the second upper sheave 12, the counterweight-side sheave 3a and the diverting sheave 11 and the second end is fastened to the rope hitch Bb attached to the counterweight 3. When the second part of the main rope 4 extending on the side of the counterweight 3 is pulled by a desired length and the first part of the main rope 4 extending on the side of the cage 2 is increased by the same length to move the cage 2 down, the distance of upward movement of the counterweight 3 is half the distance of the downward movement of the cage 2.

In the elevator 1, the three parts of the main rope 4 respectively extending between the rope hitch 8b and the diverting sheave 11, between the diverting sheave 11 and the counterweight-side sheave 3a, and between the counterweight-side sheave 3a and the second upper sheave 12 are parallel. Therefore, the vertical stroke of the counterweight 3 is half that of the cage 2. Thus, the stroke of the counterweight 3 is half the overall height of the elevator shaft 5 and hence an empty space in which the counterweight 3 does not move can be secured under the counterweight 3. In this embodiment, the counterweight 3 is suspended so as to move in the upper half of the counterweight moving space and hence the empty space is secured under the counterweight 3, the counterweight 3 may be suspended so as to move in the lower half of the counterweight moving space to secure the empty space over the counterweight 3.

Thus, the counterweight 3 can be replaced with a larger counterweight having a height and a weight greater than those of the counterweight 3 without changing the arrangement of the first upper sheave 9, the second upper sheave 12, and the hoist 6, the cage-side guide rails 7a and 7b.

Since the empty space in which the counterweight 3 does not move can be secured under (or over) the counterweight 3, a sufficient space for accommodating the first upper sheave 9, the second upper sheave 12, the hoist 6 and the controller 13 can be secured even if the counterweight 3 is replaced with a larger counterweight to avoid the unstable vertical movement of the cage 2.

In this elevator 1, the attitude of the cage 2 during vertical movement can be stabilized by properly arranging the first upper sheave 9, the second upper sheave 12, the hoist 6 and such in the empty space in which the counterweight 3 does not move taking into consideration the positions of the cage-side guide rails 7a and 7b. Thus, the elevator 1 is able to deal with the enlargement of the cage 2 and the resultant enlargement of the counterweight 3.

Since the counterweight 3 can be replaced with a larger one without changing the arrangement of the upper sheaves 9 and 12, the hoist 6 and the cage-side guide rails 7a and 7b, and with a sufficient space for arranging those components secured, the controller 13 can be disposed near the hoist 6, troubles in controlling the hoist 6 by the controller 13 due to the effect of noise can surely be prevented.

Since the freedom of disposition of the hoist 6 is enhanced, any elevator machinery room does not need to be formed on top of the elevator shaft 5. The twist of the main rope 4, which occurs when the hoist 6 is disposed perpendicularly to the upper sheaves 9 and 12, can surely be avoided.

Since the main rope 4 wound around the upper sheaves 9 and 12 is wound around the lower side of the drive sheave 6a, the main rope 4 can firmly be wound round the drive sheave 6a by tension developed in the main rope 4 by the cage 2 and the counterweight 3 and hence the driving force of the drive sheave 6a can surely be transmitted to the main rope 4.

### Second Embodiment

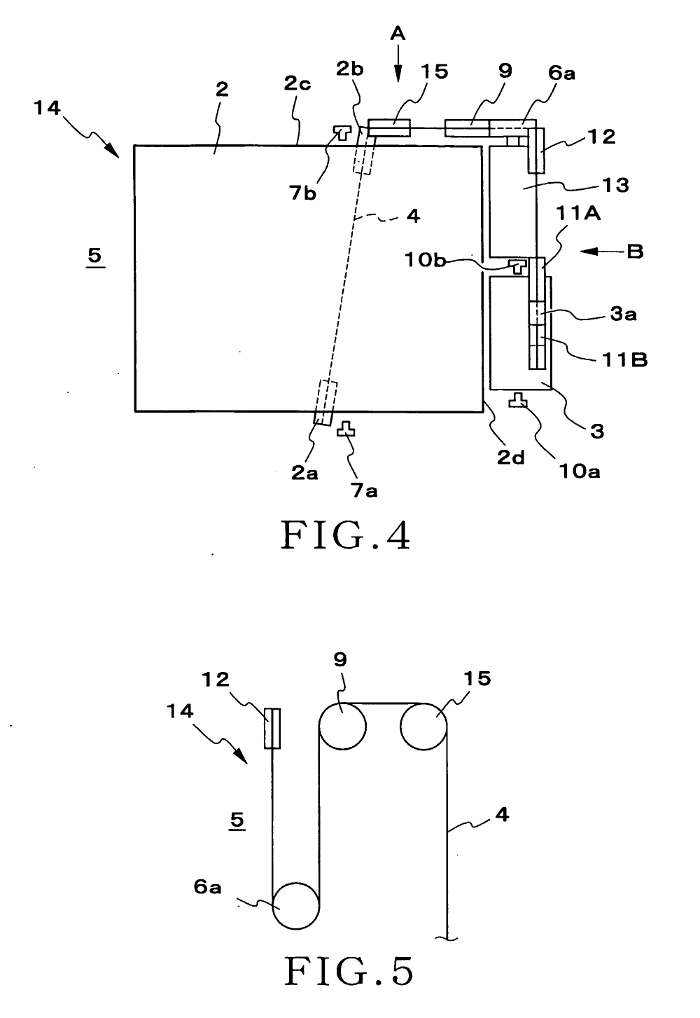

An elevator 14 in a second embodiment according to the present invention will be described with reference to FIGS. 4 to 6, in which parts like or corresponding to those of the elevator 1 in the first embodiment are denoted by the same reference characters and the description thereof will be omitted.

Referring now to FIGS. 4 and 5, the elevator 14 has a cage 2 having a back wall 2d opposite a front wall provided with an entrance, and a counterweight 3 suspended in a space between the back wall 2d of the cage 2 and a wall, not shown, of an elevator shaft 5. A diverting sheave 15 is disposed above a second cage-side sheave 2b attached to the cage 2 in the space between a sidewall 2c of the cage 2 and a sidewall, not shown, of the elevator shaft 5. A part of a main rope 4 extends substantially vertically between one side of the diverting sheave 15 and one end of the cage-side sheave 2b. The main rope 4 is wound around the upper side of the diverting sheave 15, is passed along the top wall of the elevator shaft 5, is wound around the upper side of a first upper sheave 9 disposed near a back corner of the elevator shaft 5 behind the diverting sheave 15, is extended substantially vertically down from the first upper sheave 9 to a drive sheave 6a mounted on the drive shaft of a hoist 6, is wound around the drive sheave 6a, is extended substantially vertically up from the drive sheave 6a to a second upper sheave 12, and is wound around the upper side of the second upper sheave 12. The first upper sheave 9 and the second upper sheave 12 are substantially at the same level.

The first upper sheave 9 is disposed in a space between a part, on the side of the back wall 2d, of the side wall 2c of the cage 2 and a side wall of the elevator shaft 5 as viewed in a projection on a horizontal plane. The axis of rotation of the first upper sheave 9 is substantially perpendicular to the sidewall 2c of the cage 2. The second upper sheave 12 is disposed behind the first upper sheave 9 in an upper part of the elevator shaft 5 with its axis of rotation extended substantially perpendicularly to the axis of rotation of the first upper sheave 9.

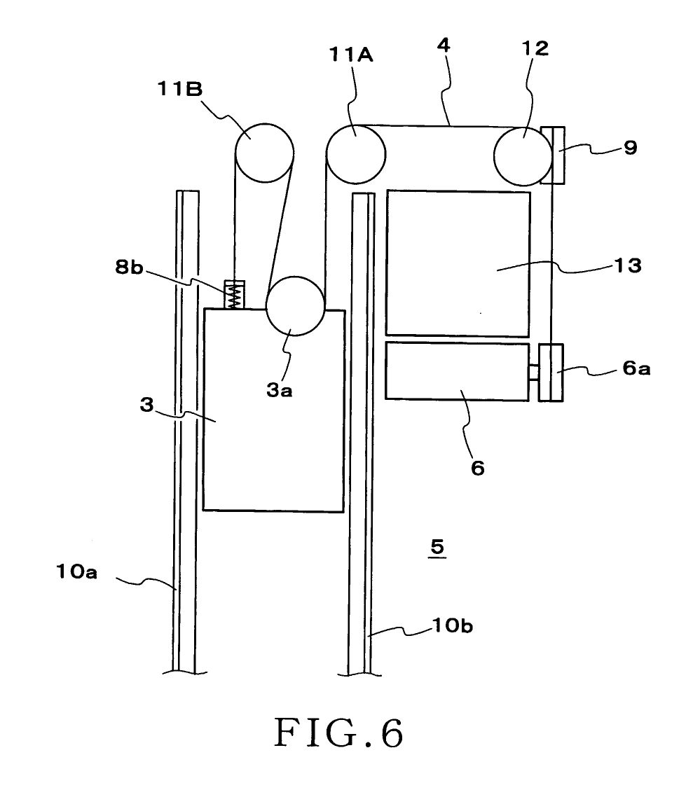

Referring to FIGS. 4 and 6, the counterweight 3 is suspended in a space between one side of the back wall 2d of the cage 2 and a wall of the elevator shaft 5, with its right and left sides being reverted as the counterweight 3 of the first embodiment. A first diverting sheave 11A and a second diverting sheave 11B are arranged in parallel to the width of the cage 2 and are supported for rotation in a space extending over the counterweight 3. Although not illustrated, the first diverting sheave 11A is supported on the upper end of a counterweight-side guide rail 10b for guiding the vertical movement of the counterweight 3.

The hoist 6 drives the cage 2 and the counterweight 3 through the main rope 4. The hoist 6 is fixedly disposed in a space between the other side of the back wall 2d of the cage 2 and the wall of the elevator shaft 5. The hoist 6 is disposed such that the hoist 6 does not overlap the cage 2 and the counterweight 3 in a projection on a vertical plane. The axis of the drive sheave 6a of the hoist 6 is parallel to that of the first upper sheave 9, and is perpendicular to that of the second upper sheave 12. The hoist 6 is disposed such that parts of the main rope 4 extend substantially vertically up from the opposite sides of the drive sheave 6a to one side of the first upper sheave 9 and one side of the second upper sheave 12, respectively. A controller 13 that controls the hoist 6 is fixedly disposed at a position above the hoist 6 in a space between one side of the back wall 2d of the cage 2 and the wall of the elevator shaft 5 as shown in FIG. 6.

Referring to FIGS. 4, 5 and 6, the main rope 4 has a first end fastened to a rope hitch 8a attached to the upper end of a cage-side guide rail 7a, and a second end fastened to a rope hitch 8b attached to the counterweight 3. The main rope 4 is extended substantially vertically down from the rope hitch 8a to a cage-side sheave 2a, is wound around the cage-side sheave 2a and another cage-side sheave 2b, is extended substantially vertically up from the cage-side sheave 2b to the diverting sheave 15, is wound around the diverting sheave 15 and the first upper sheave 9, is extended substantially vertically down from the first upper sheave 9 to the drive sheave 6a, is wound around the drive sheave 6a, is extended substantially vertically up from the drive sheave 6a to the second upper sheave 12, is wound around the second upper sheave 12 and the first diverting sheave 11A, is extended substantially vertically down from the first diverting sheave 11A to the counterweight-side sheave 3a of the counterweight 3, is extended substantially vertically up from the counterweight-side sheave 3a to the second suspension sheave 11B, is wound around the second suspension sheave 11B and is extended from the second suspension sheave 11B to the rope hitch 8b attached to the counterweight 3.

The vertical stroke of the counterweight 3 of the elevator 14 in the second embodiment, similarly to that of the counterweight 3 of the elevator 1 in the first embodiment, is half the vertical stroke of the cage 2, the elevator 14 has enhanced freedom of arrangement of the component parts and devices.

Since the freedom of disposition of the hoist 6 of the elevator 14, similarly to that of the elevator 1 in the first embodiment, is enhanced, any elevator machinery room does not need to be formed on top of the elevator shaft 5.

### Third Embodiment

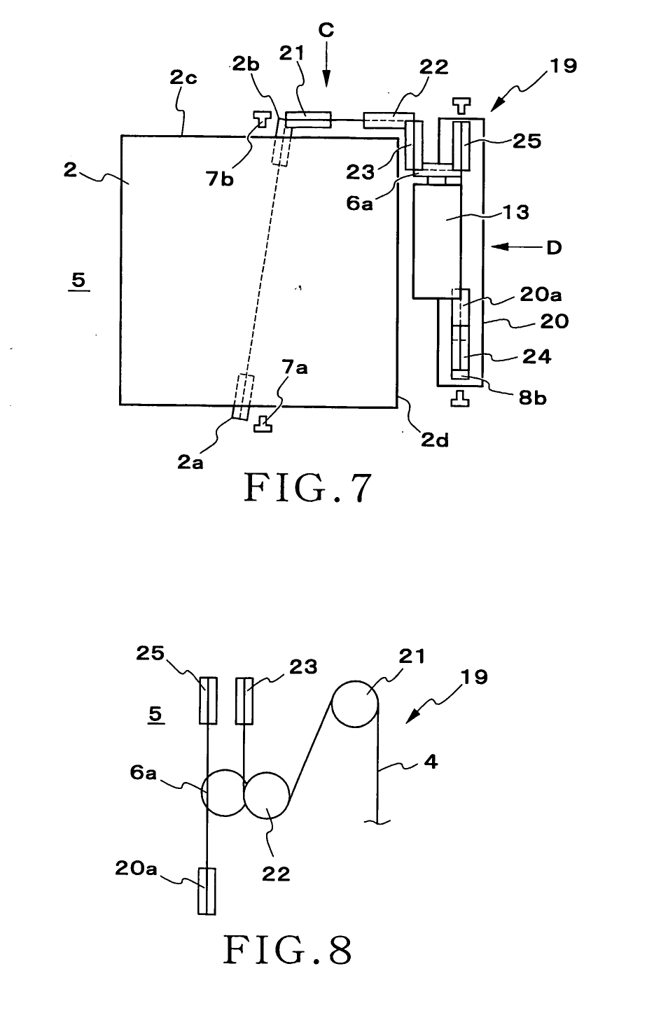

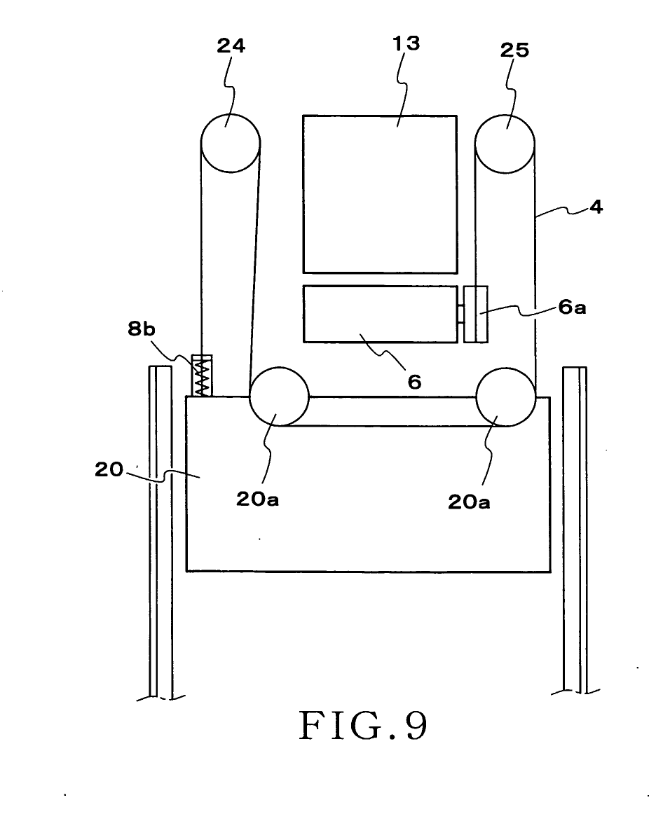

An elevator 19 in a third embodiment according to the present invention will be described with reference to FIGS. 7 to 9, in which parts like or corresponding to those of the elevator 1 in the first embodiment are denoted by the same reference characters and the description thereof will be omitted. FIG. 7 is a plan view of an elevator in a third embodiment of the present invention. FIG. 8 is a side elevation of the elevator shown in FIG. 7, taken in the direction of the arrow c in FIG. 7. FIG. 9 is a side elevation of the elevator shown in FIG. 7, taken in the direction of the arrow d in FIG. 7.

Referring to FIG. 7, the elevator 19 has a cage 2, and a counterweight 20 suspended in a space between the back wall 2d of the cage 2 and a wall, not shown, of an elevator shaft 5. The counterweight 20 has a width substantially corresponding to that of the space between the back wall 2d of the cage 2 and the wall of the elevator shaft 5.

Referring to FIGS. 7 and 8, a first diverting sheave 21 is supported on a wall of the elevator shaft 5 facing the side wall 2c of the cage 2, and a main rope 4 is extended substantially vertically between the first diverting sheave 21 and a second cage-side sheave 2b attached to the cage 2. The main rope 4 is extended from the first diverting sheave 21 via a second diverting sheave 22 and a first upper sheave 23 to a drive sheave 6a mounted on the drive shaft of a hoist 6 and is wound around the drive shaft 6a.

The second diverting sheave 22 is disposed at a level below that at which the first diverting sheave 21 is disposed at a position near the back end of the sidewall 2c of the cage 2 in a space between the sidewall 2c and a sidewall of the elevator shaft 5. The axis of rotation of the second diverting sheave 22 is perpendicular to the sidewall 2c of the cage 2. The first upper sheave 23 is disposed at a level substantially the same as that of the first diverting sheave 21 in a space between a part of the back wall 2d of the cage 2 near the sidewall 2c and a wall of the elevator shaft 5. The axis of rotation of the first upper sheave 23 is perpendicular to the back wall 2d of the cage 2. As shown in FIG. 7, the main rope 4 is extended substantially vertically down from one side of the first upper sheave 23 to one side of the second diverting sheave 22.

Referring to FIGS. 7 and 9, a counterweight 20 is suspended in a space between the back wall 2d of the cage 2 and a wall, facing the back wall of the elevator shaft 5. The counterweight 20 has a width substantially corresponding to that of the back wall 2d of the cage 2. Counterweight-side sheaves 20a are supported for rotation on the upper surface of the counterweight 20 at a position near a first end of the upper surface of the counterweight 20, and at a position near a second end of the upper surface of the counterweight 20 and slightly nearer to the middle of the upper surface of the counterweight 20, respectively, with respect to the width of the counterweight 20. A rope hitch 8b is attached to the second end of the upper surface of the counterweight 20.

A diverting sheave 24 is disposed above the counterweight 20 with its axis of rotation extended perpendicularly to the back wall 2d of the cage 2. A part of the main rope 4 is extended substantially vertically down from one side of the diverting sheave 24 to the center of the rope hitch 8b, and a part of the main rope 4 is extended substantially vertically down from the other side of the diverting sheave 24 to one side of one of the counterweight-side sheaves 20a.

A second upper sheave 25 is disposed above the other counterweight-side sheave 20a attached to the counterweight 20. The second upper sheave 25 is on substantially the same level as the first diverting sheave 21, the diverting sheave 24 and the first upper sheave 23 in the elevator shaft 5. The second upper sheave 25 is disposed behind the first upper sheave 23 opposite to the latter.

The hoist 6 drives the cage 2 and the counterweight 3 for vertical movement through the main rope 4. The hoist 6 is fixedly disposed at a position above the counterweight 20 in a space between the back wall 2d of the cage 2 and a wall of the elevator shaft 5. The axis of rotation of the drive sheave 6a mounted on the drive shaft of the hoist is substantially perpendicular to those of the first upper sheave 23 and the second upper sheave 25. The hoist 6 is disposed such that parts of the main rope 4 extend substantially vertically up from the opposite sides of the drive sheave 6a to the other sides of the first upper sheave 23 and the second upper sheave 25, respectively. A controller 13 that controls the hoist 6 is fixedly disposed at a position above the hoist 6 in a space between the back wall 2d of the cage 2 and the wall of the elevator shaft 5.

Referring to FIGS. 7, 8 and 9, the main rope 4 has a first end fastened to a rope hitch 8a, not shown, attached to the upper end of a cage-side guide rail 7a on the side of the cage 2, and a second end fastened to a rope hitch 8b attached to the counterweight 20. The main rope 4 is extended substantially vertically down from the rope hitch 8a to a cage-side sheave 2a, is wound around the cage-side sheave 2a and another cage-side sheave 2b, is extended substantially vertically up from the cage-side sheave 2b to the first diverting sheave 21, is wound around the first diverting sheave 21 and the second diverting sheave 22, is extended substantially vertically up from the second diverting sheave 22 to the first upper sheave 23, is wound around the first upper sheave 23, is extended substantially vertically down from the first upper sheave 23 to the drive sheave 6a, is wound around the drive sheave 6a, is extended substantially vertically up from the drive sheave 6a to the second upper sheave 25, is wound around the second upper sheave 25, is extended substantially vertically down fro the second upper sheave 25 to one of the counterweight-side sheaves 20a, is wound around the two counterweight-side sheaves 20a, is extended substantially vertically up from the other counterweight-side sheave 20a to the diverting sheave 24, is wound around the diverting sheave 24, and is extended from the diverting sheave 24 to the rope hitch 8b attached to the counterweight 20.

Thus, the elevator 14 in the third embodiment has enhanced freedom of determination of the width of the counterweight 20, and, when the cage 2 is replaced with a larger one, the counterweight 20 can be replaced with a counterweight suitable for use in combination with the larger cage 2.

### Fourth Embodiment

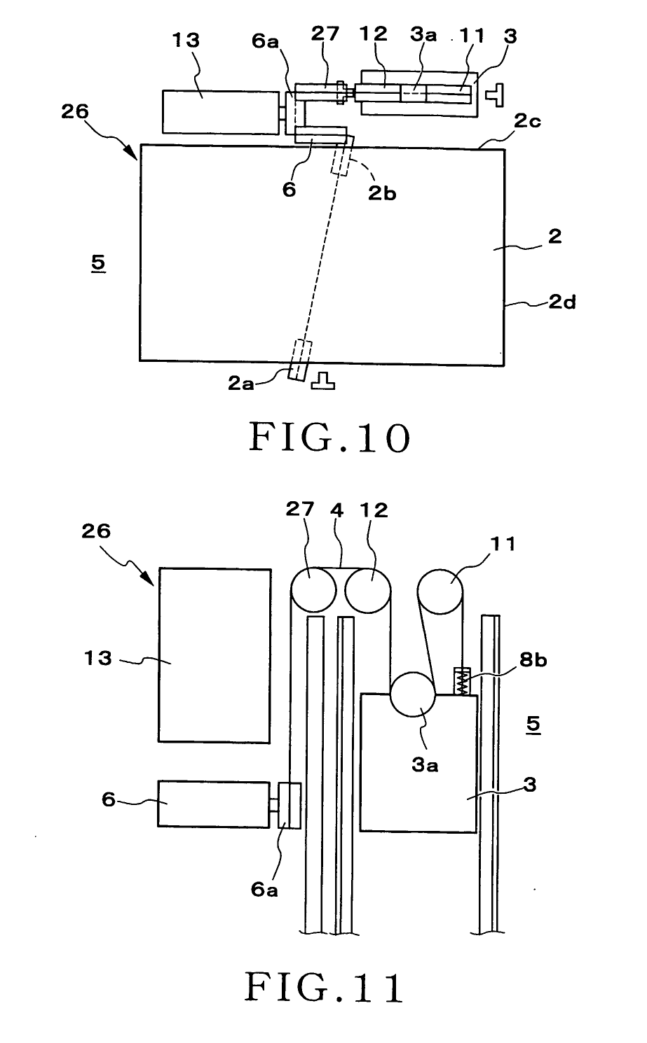

An elevator 26 in a fourth embodiment according to the present invention will be described with reference to FIGS. 10 and 11.

Referring now to FIG. 10, the elevator 26 has a cage 2 suspended in an elevator shaft 5, and a counterweight 3 suspended in a space between a sidewall 2c of the cage 2 and a wall of the elevator shaft 5. As shown in FIGS. 10 and 11, positions where the counterweight 3 and a diverting sheave 11 are disposed, and positions where a hoist 6 and a controller 13 are disposed in the elevator 26, and those in the elevator 1 in the first embodiment are symmetrical with respect to a lateral direction. A second upper sheave 12 is disposed above the counterweight 3, and a third upper sheave 27 is disposed between the second upper sheave 12 and a drive sheave 6a mounted on the drive shaft of the hoist 6 in a passage of a main rope 4.

The third upper sheave 27 is disposed behind a first upper sheave 9 in parallel to the latter at substantially the same level as the first upper sheave 9 and the diverting sheave 11 in an upper part of the elevator shaft 5. The third upper sheave 27 is parallel to a sidewall 2c of the cage 2. A part of the main rope 4 is extended substantially vertically down from one side of the third upper sheave 27 to one side of the drive sheave 6a mounted on the drive shaft of the hoist 6.

The main rope 4 is extended substantially vertically up from the drive sheave 6a to the third upper sheave 27, is wound around the third upper sheave 27 and the second upper sheave 12, is extended substantially vertically down from the second upper sheave 12 to a counterweight-side sheave 3a attached to the counterweight 3, is extended from the counterweight-side sheave 3a, and is wound around the diverting sheave 11. The main rope 4 has one end fastened to a rope hitch 8b attached to the counterweight 3.

The operation and effect of the fourth embodiment are the same as those of the first embodiment.

Although the present invention has been described in its preferred embodiments, the present invention is not limited in its practical application to the preferred embodiments specifically described herein and various changes and modifications are possible. For example, the main rope 4 is extended from the hoist 6 and passed through the first upper sheave 9 and the second upper sheave 12 in the foregoing embodiments, either the first upper sheave 9 or the second upper sheave 12, or both may be omitted and the drive sheave 6a of the hoist 6 may be used as an upper sheave.

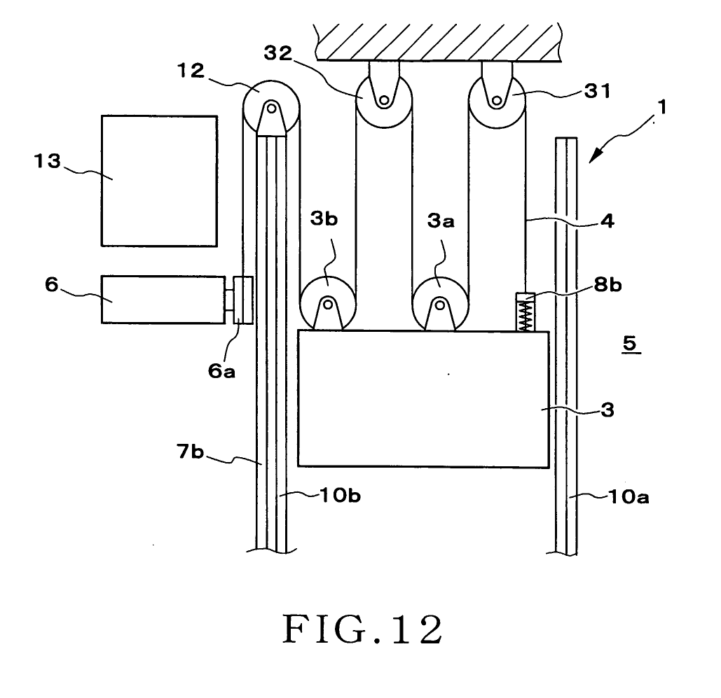

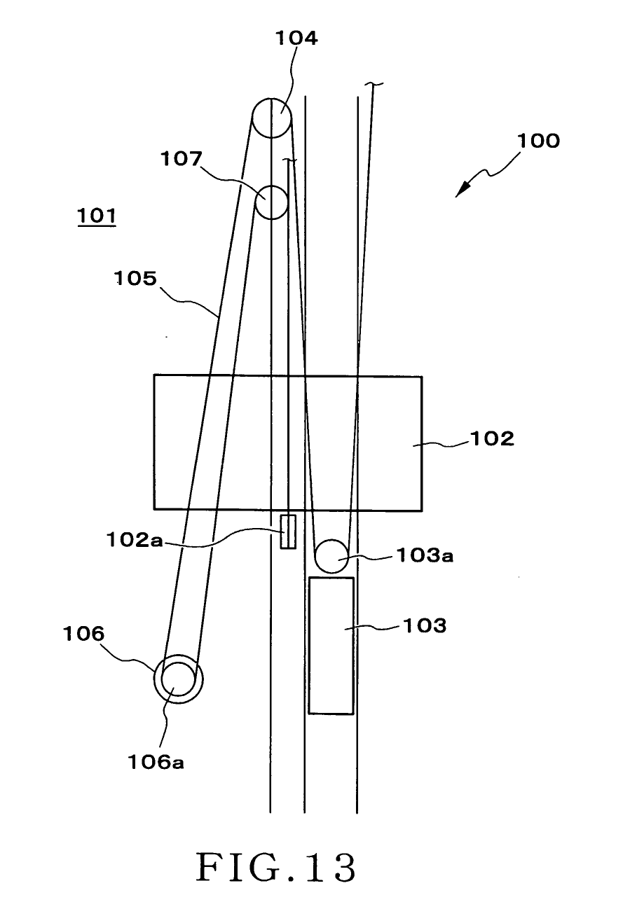

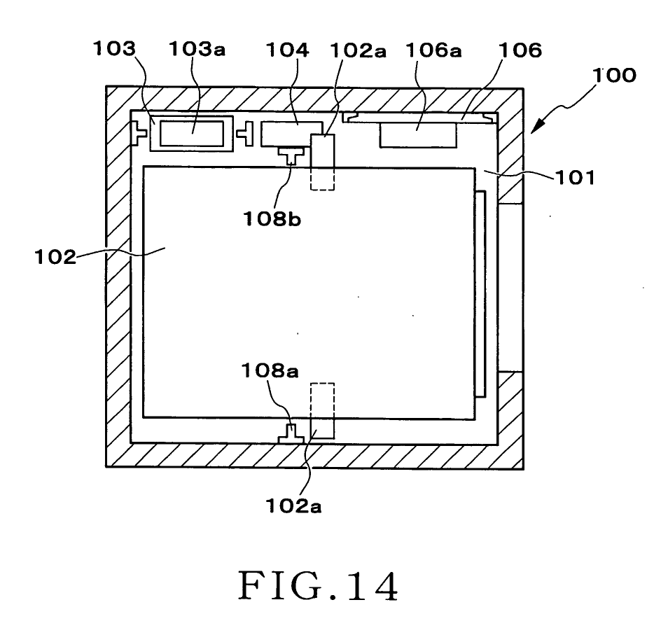

It is also possible to modify the elevator 1 in the first embodiment to further reduce the vertical stroke of the counterweight 3 by attaching two counterweight-side sheaves 3a and 3b to the upper surface of the counterweight 3, and using two suspension sheaves 31 and 32 as shown in FIG. 12. The elevator of the present invention may be provided with three or more counterweight-side sheaves, and three or more suspension sheaves.

As apparent from the foregoing description, according to the present invention, the vertical stroke of the counterweight is half that of the cage, and a space in which the counterweight does not move can be secured over or under the counterweight. Accordingly, the counterweight can be replaced with a larger one having a greater height without changing the arrangement of the component parts and devices including the upper sheaves.

Since the vertical stroke of the counterweight is half that of the cage, the elevator has enhanced freedom of arrangement of the component parts and devices.

Since a space in which the counterweight does not move can be secured over or under the counterweight, a sufficient space for installing the components including the upper sheave can be secured even if the counterweight is replaced with a larger one having a greater height, so that the unstable vertical movement of the cage can be avoided. When the cage is replaced with a larger one, the counterweight can be replaced with a counterweight suitable for use in combination with the larger cage.

According to the present invention, the vertical stroke of the counterweight can be reduced to less than half the vertical stroke of the cage.

1. An elevator comprising:
a cage vertically moving in a cage moving space arranged in an elevator shaft, and having at least one cage-side sheave;
a counterweight vertically moving in a counterweight moving space arranged beside the cage moving space in the elevator shaft, and having at least one counterweight-side sheave;
a diverting sheave disposed above the counterweight moving space;
a pair of upper sheaves disposed in a top part of the counterweight moving space;
a hoist disposed in a space in the elevator shaft other than both the cage moving space and the counterweight moving space, and having a drive sheave positioned below the pair of upper sheaves; and
a main rope successively wound around the cage-side sheave, one of the pair of upper sheaves, the drive sheave, the other upper sheave, the counterweight-side sheave and the diverting sheave, said main rope having a first end fastened to an upper part of the elevator shaft and a second end fastened to the counterweight.

2. An elevator comprising:
a cage vertically moving in a cage moving space arranged in an elevator shaft, and having at least one cage-side sheave;
a counterweight vertically moving in a counterweight moving space arranged beside the cage moving space in the elevator shaft, and having a plurality of counterweight-side sheaves;
a plurality of diverting sheaves disposed above the counterweight moving space;
a pair of upper sheaves disposed in a top part of the counterweight moving space;
a hoist disposed in a space in the elevator shaft other than both the cage moving space and the counterweight moving space, and having a drive sheave positioned below the pair of upper sheaves; and
a main rope successively wound around the cage-side sheave, one of the pair of upper sheaves, the drive sheave, the other upper sheave, one of the counterweight-side sheaves, one of the diverting sheaves, the other counterweight-side sheave, and the other diverting sheave, said main rope having a first end fastened to an upper part of the elevator shaft and a second end fastened to the counterweight.

3. The elevator according to claim 1 or 2, wherein the cage-side sheaves are a first cage-side sheave and a second cage-side sheave disposed at opposite side positions, respectively, on a bottom surface of the cage, and a part of the main rope wound around the first cage-side sheave has a free end fastened to a fixed part in an upper part of the elevator shaft.

4. The elevator according to any one of claims 1 to 3, wherein the counterweight moving space is on a side of one of sidewalls of the cage.

5. The elevator according to any one of claims 1 to 4, wherein the counterweight moving space is on a side of a back wall of the cage opposite a front wall of the cage provided with an exit door.

6. The elevator according to claim 5, wherein a diverting sheave is disposed at a position above the second cage-side sheave in an upper part of the elevator shaft, and the main rope is guided to the counterweight moving space on the side of the back wall of the cage opposite the front wall of the cage provided with an exit door by the second cage-side sheave and one of the upper sheaves.
